(19) United States
(12) Patent Application Publication
(10) Pub. No.: US 2011/0290187 A1
(43) Pub. Date: Dec. 1, 2011

(54) Protective enclosure for wild bird feeder

(76) Inventor: Bertram Mindell, Middlesex (GB)

(21) Appl. No.: 12/801,256

(22) Filed: May 28, 2010

(51) Int. Cl. A01K 39/01

(52) U.S. Cl. 119/57.9

(57) ABSTRACT

A protective enclosure for a wild bird feeder or for feeding wild birds has apertures sized to selectively restrict access to its interior and comprises an outer mesh section (1) overlying an inner mesh section (2), said mesh sections being loosely mutually connected by one or more link members (5) extending into a space between the mesh sections and allowing relative lateral displacement of the inner and outer mesh sections to vary the effective size of said apertures. The link members are suitably hooked over horizontal bars (6d) of the outer mesh section and the effective aperture size (A/a) can be varied by rotating the inner mesh section (2).

### FIELD OF THE INVENTION

The present invention relates to a protective enclosure for a wild bird feeder and relates to wild bird feeder arrangements incorporating such a protective enclosure. The protective enclosure may surround a bird table or a suspended bird feeder, for example.

### BACKGROUND OF THE INVENTION

It is desirable to control the size of the apertures of a protective enclosure for a wild bird feeder in order to allow selective access to the wild birds of interest and to exclude unwanted birds as well as pests such as rodents, particularly squirrels, for example.

By way of background information, U.S. Pat. No. 3,738,324 (Keen) dating from 1973 discloses a poultry feed trough having a “grill and guard arrangement” in which a guard in the form of a mesh section is pivotally attached to the grille of the underlying feed trough by a sliding hinge in the form of a tube located around the adjacent parallel bars of the guard and grille respectively. In one embodiment the guard can be slid in the direction of the hinge (tube) axis to adjust the size of the apertures, with the aim of allowing smaller chickens to feed without danger of falling into the trough by reducing the size of the apertures and allowing larger chickens to feed by providing larger apertures. After adjustment the guard can be secured in position with a latch.

U.S. Pat. No. 2,221,013 (White) and U.S. Pat. No. 1,672,043 (Seikman) similarly disclose poultry feed troughs with adjustable feed apertures. These poultry feeders comprise grids having parallel bars which can be slid over similar underlying grids to vary the bar spacing and hence the effective width of the feed apertures.

Such domestic bird feeding arrangements are not suitable for enclosing a wild bird feeder or for excluding pests, and would normally be used in a poultry house or other environment in which pests and wild creatures are already excluded.

In GB 2417183B, in the name of the present applicant, a protective cage enclosure for a wild bird feeder is disclosed in which the relative positions of inner and outer mesh sections can be adjusted and fixed in position to enable the effective aperture size of the cage to be adjusted. This patent discloses extensions in the form of tabs located at the edges of and coplanar with their mesh sections. These tabs can be clamped against the bars of the underlying mesh with a screw clamp. More generally, “clips, screws, clasps, clamps, springs or other forms of attachment” are disclosed in this patent.

However, while this arrangement has proved to be advantageous over previous designs, it is restricted to cages formed of planar mesh sections and does not allow for any spacing between the inner and outer mesh sections or for any significant tolerance in such spacing, and this places extra demands on manufacture.

Furthermore when the clamps or “other forms of attachment” are loosened, there is a risk of one mesh section becoming detached from the other and it can be fiddly to re-position the mesh sections so that they can be re-attached.

### BRIEF SUMMARY OF THE INVENTION

An object of the present invention is to provide an adjustable protective enclosure for a wild bird feeder or for feeding wild birds, in which a movable mesh section is retained on the enclosure even while it is being moved to adjust the effective size of the openings.

A further object of the present invention is to provide a generally cylindrical protective enclosure for a wild bird feeder or for feeding wild birds, in which the effective size of the openings can be adjusted by the user.

A further object of the present invention is to provide a generally cylindrical protective enclosure for a wild bird feeder or for feeding wild birds, in which there is a spacing between inner and outer mesh sections thereof.

Accordingly the invention provides a protective enclosure for a wild bird feeder or for feeding wild birds, in which the protective enclosure has a generally cylindrical mesh wall comprising an outer mesh section overlying an inner mesh section. The outer and inner mesh sections have respective mutually offset arrays of apertures for forming openings which selectively restrict access to within the protective enclosure. One or more link members allow the relative orientation of the outer and inner mesh sections to be adjusted about a longitudinal axis of the cylindrical mesh wall to vary the effective size of its openings.

Such an arrangement is particularly suitable for a generally cylindrical protective enclosure in which the outer mesh section surrounds the inner mesh enclosure, because the adjustment of the mesh sizes is relatively easy and typically involves rotating one (normally the inner) mesh section about the cylinder axis.

In a preferred embodiment the link members connecting the inner and outer mesh sections are in the form of hooks and/or brackets.

Preferably the inner and outer mesh sections are provided with releasable securing means for allowing adjustment of the effective size of said openings only when the securing means is released.

Preferably the releasable securing means comprises at least one screw clamp.

Preferably the clamp secures a projecting member carried by one of the inner and outer mesh sections in a circumferential slot in a plate carried by the other mesh section.

Preferably the projecting member is threaded and can be screwed onto another threaded member to allow the mesh sections to be clamped in position.

In a preferred embodiment the outer mesh section extends around the inner mesh section and a plurality of link members project in a radial direction from one of the mesh sections and engage the other of the mesh sections. Optionally the link members (which are suitably formed of rod or strip, for example) hook over portions of the other mesh section. This arrangement provides a convenient and economical construction in which one mesh section is adjustably supported on the other.

Preferably the more link members maintain a substantially uniform spacing between the mesh sections. This feature helps to locate the adjustable (normally the inner) mesh section so that it can be clamped in position after being moved to adjust the effective opening sizes, and also tends to protect the inner mesh section against attack by pests such as squirrels for example.

In a preferred embodiment the link members are elongate, and are attached to and project in a radial direction from one of the mesh sections. This helps maintain a spacing between the mesh sections. In this embodiment, preferably the one or more link members are in the form of a bent rod or strip.

### BRIEF DESCRIPTION OF THE DRAWINGS

FIG. 1 is an elevation of a preferred enclosure in accordance with the invention for a wild bird feeder;

FIG. 2 is a diagrammatic cross-section taken on II-II of FIG. 1, and

FIG. 3 is a diagrammatic cross-section taken on III-III of FIG. 2.

### DETAILED DESCRIPTION OF THE INVENTION

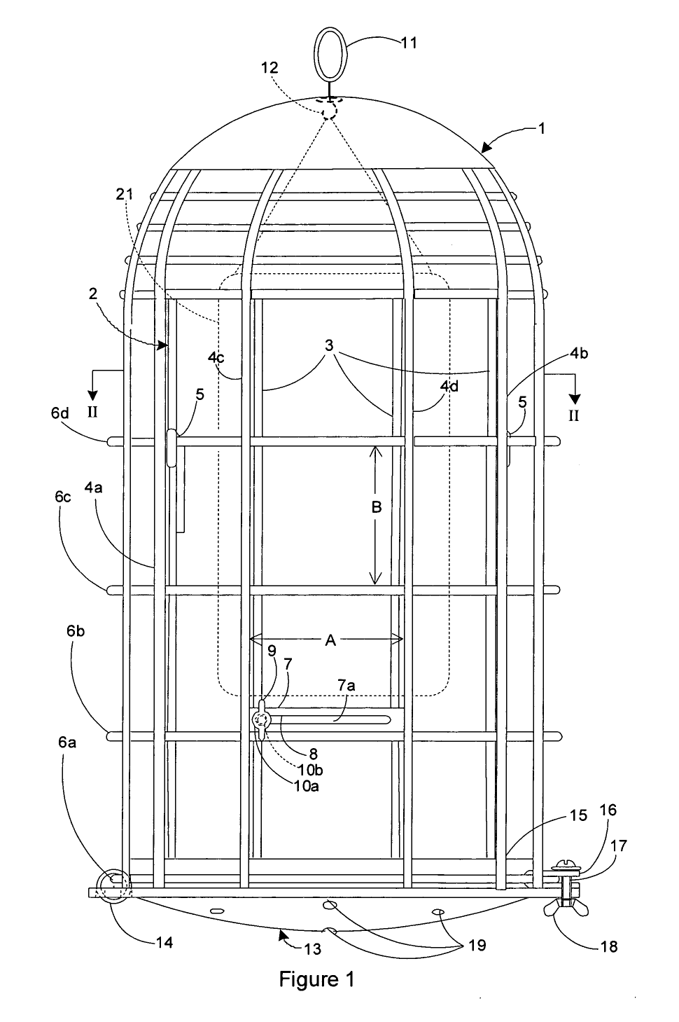

Referring to FIG. 1, the enclosure or tube sanctuary shown comprises an outer, generally cylindrical mesh section 1, an inner tubular mesh section 2 surrounded by the outer mesh section and a base 13 which is attached to the lower end of mesh section 1 and can be opened to provide access to a conventional bird feeder 21 located within inner mesh section 2 and supported on an internal hook 12 of the outer mesh section 1. The bird feeder suitably contains nuts or other bird food.

Outer mesh section 1 has a lower tubular portion constructed from horizontal steel wire rings 6a to 6d on the exterior of which are welded upright steel wire rods 4. The outside diameter of the wire rings 6a to 6d is suitably 190 mm. The diameter of the steel wire is suitably 3 mm for the rings 6a to 6d and 2 mm for the upright rods 4. The upper domed portion has a similar construction but the wire rings are more closely spaced to prevent access by birds to the open upper mouth of the inner mesh section 2.

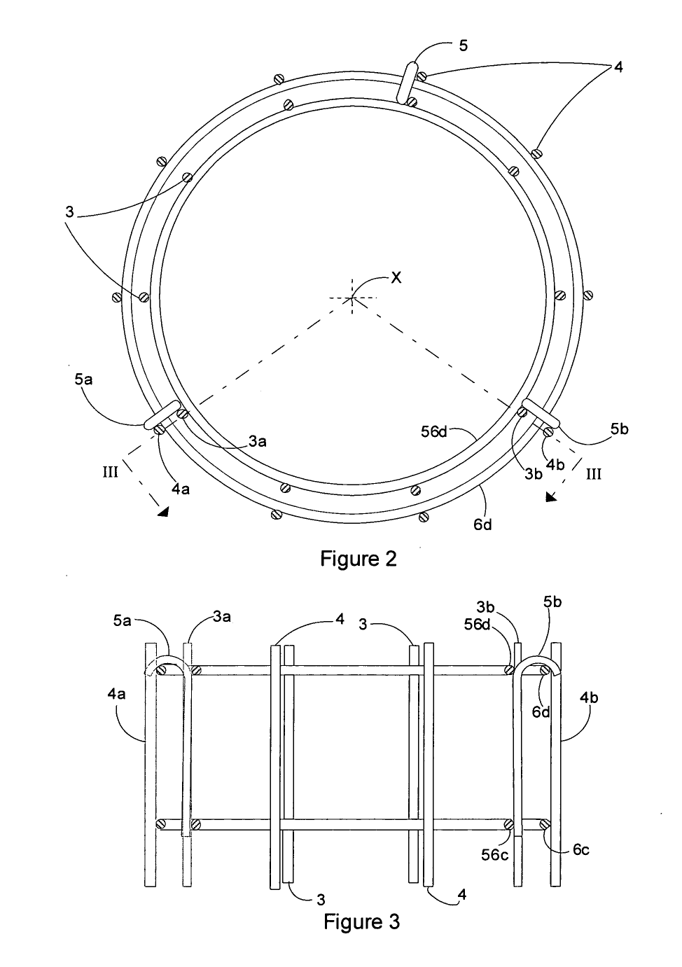

Inner mesh section 2 has a similar construction to the tubular portion of the outer mesh section and is constructed from horizontal steel wire rings (hidden in FIG. 1 but visible as 56d in FIGS. 2 and 56c and 56d in FIG. 3) on the exterior or which are welded upright steel wire rods 3. The diameter of the steel wire is suitably 3 mm for the rings 56c and 56d and 2 mm for the upright rods 4. The outside diameter of the wire rings 56c and 56d is suitably 170 mm. The above steel mesh sections are suitably constructed from stainless steel or mild steel provided with a suitable coating to protect it against rust.

Inner mesh section 2 is supported within the outer mesh section by three link members 5, as best seen in FIGS. 2 and 3. Link members 5a and 5b are referenced separately in these Figures, as are their associated upright rods 3a, 3b and 4a, 4b. It will be seen that each link member 5a/5b in this embodiment is in the form of a length of wire hooked at its upper end, the hook projecting radially outwardly towards a wire ring 6d of the outer mesh section over which it is hooked. Each link member 5a/5b is welded to its associated upright rod member 3a/3b.

As best seen in FIG. 2, the inner mesh section 2 is uniformly spaced apart from the outer mesh section 1, the spacing suitably being 5 mm or less.

Referring again to FIG. 1, outer mesh section 1 carries a clamping arrangement comprising a plate 7 welded to adjacent upright wire rods 3 and having a horizontal, circumferentially-extending slot 8 which receives a radially outwardly-projecting captive bolt 10. Captive bolt 10 is mounted on a plate 7a which is welded to adjacent upright wire rods 4b and 4c of the inner mesh section 2. A wing nut 10 is screwed onto bolt 10.

Accordingly, with the above clamping arrangement loosened, inner mesh section 2 can be rotated about its vertical longitudinal axis X (FIG. 2) relative to outer mesh section 1 to vary the effective width of the openings formed by the mesh apertures from a maximum of A (the spacing between rods 3 which is equal to the spacing between the rods 4, and is typically 56 mm) to a little under half this spacing, about 26 mm in this case. FIGS. 1, 2 and 3 show the configuration with the maximum spacing A, corresponding to alignment of the rods 3 and rods 4 and hence exact registration of the apertures in the inner and outer mesh sections.

Base 13 is provided with a ring 14 which extends through two apertures therein and is fitted around bottom ring 6a of outer mesh section 1 to provide a hinged connection. The base is secured to the diametrically opposite side of ring 6a by a generally U-shaped clamp 16 which extends around the ring and receives a bolt 17 through registering apertures in its opposite limbs, these apertures being aligned with a similar aperture in the peripheral region of base 13. The bolt screws into a wing nut 18.

A skirt 15 is formed on the upper surface of base 13 and fits within outer mesh section 1 and surrounds the lower periphery of inner mesh section 2. Drainage holes 19 are formed in base 13.

In a variant, the bird feeder 21 could be omitted and feed placed in the base of the enclosure.

1. A protective enclosure for a wild bird feeder or for feeding wild birds, said protective enclosure having:
i) a generally cylindrical mesh wall comprising an outer mesh section overlying an inner mesh section, said outer and inner mesh sections having respective mutually offset arrays of apertures for forming openings which selectively restrict access to within said protective enclosure, said generally cylindrical mesh wall having a longitudinal axis, and
ii) one or more link members for allowing the relative orientation of said outer and inner mesh sections about said longitudinal axis to be adjusted to vary the effective size of said openings.

2. A protective enclosure according to claim 1, wherein said inner and outer mesh sections are provided with releasable securing means for allowing adjustment of the effective size of said openings only when said securing means is released.

3. A protective enclosure according to claim 2 wherein said releasable securing means comprises at least one screw clamp.

4. A protective enclosure according to claim 3 wherein said clamp secures a projecting member carried by one of said inner and outer mesh sections in a circumferential slot in a plate carried by the other of said inner and outer mesh sections.

5. A protective enclosure according to claim 4 wherein said projecting member is threaded and can be screwed onto another threaded member to allow the mesh sections to be clamped in position.

6. A protective enclosure according to claim 1 wherein said one or more link members maintain a substantially uniform radial spacing between said mesh sections.

7. A protective enclosure according to claim 1 wherein a plurality of said link members project in a radial direction from one of said mesh sections to engage the other of said mesh sections.

8. A protective enclosure according to claim 7 wherein said link members hook over portions of said other mesh section.

9. A protective enclosure according to claim 8 wherein a plurality of said link members are circumferentially distributed and support said inner mesh section on said outer mesh section.

10. A protective enclosure according to claim 1 wherein a base is attached to said outer mesh section and can be opened to provide access to said inner mesh section.

11. A protective enclosure according to claim 1 wherein said one or more link members are in the form of a bent rod.

12. A wild bird feeder arrangement comprising a protective enclosure as claimed in claim 1 and a wild bird feeder located in said protective enclosure.
